(19) United States
(12) Patent Application Publication
(10) Pub. No.: US 2005/0191475 A1
(43) Pub. Date: Sep. 1, 2005

(54) Poly-[vinyl alcohol] based meat processing films

(76) Inventor: Reg MacQuarrie, Toronto (CA)

Correspondence Address: Law Office;Dinesh Agarwal, P.C., Suite 330, 5350 Shawnee Road, Alexandria, VA, 22312, US

(21) Appl. No.: 10/669,631

(22) Filed: Sep. 25, 2003

Related U.S. Application Data
(60) Provisional application No. 60/421,121, filed on Sep. 26, 2002.

(51) Int. Cl. B32B 1/00

(52) U.S. Cl. 428/220; 428/500

(57) ABSTRACT

Non-edible meat processing and packaging films made of polyvinyl alcohol (PVA) instead of conventional cellulose have been found to produce films which exhibit enhanced strength and tear resistance, permeability to added smoke and other flavors, as well as additional properties useful in commercial meat processing operations. Either partially or fully hydrolyzed PVA is used, depending on whether the film is intended to remain insoluble or to dissolve off the meat product during the cooking process. A liquid composition for casting or extrusion of films according to the invention will combine PVA, water, a plasticizer and suitable hydrocolloids to act as modifying agents for processing of the film.

This application claims priority based on U.S. provisional patent application No. 60/421,121 filed on Sep. 26, 2002, which is incorporated herein by reference.

Non-edible meat processing and packaging films are conventionally made of cellulose. I have found that polyvinyl alcohol (PVA) films can be fabricated from partially or fully hydrolyzed polyvinyl alcohol in combination with one or more other hydrocolloids such Gellan, carrageenan or Konjac, particularly for the production of smoked meat products. Like cellulose, films according to my invention allow for the penetration of smoke into the meat product.

According to one embodiment of the present invention, meat product films are made from partially hydrolyzed grades of polyvinyl alcohol. The use of such partially hydrolyzed PVA films results in the film dissolving off the meat product, e.g. ham, during the cooking process.

The other general embodiment of films according to the invention uses fully hydrolyzed PVA, resulting in films which remain insoluble and are physically removed from the meat product after cooking.

Films according to the present invention are based on a formulation by weight of PVA [of selected degree of hydrolysis] in the range of 65-80%; 0-20% plasticizer; 2-20% water and 0-20% of other polymers useful as modifying agents in the film. These other polymers include suitable gums, proteins and starches. Particularly suitable are Gellan gum and Konjac gum, which serve to prevent the PVA film from dissolving in hot water and during steam processing on hands.

Suitable plasticizers are glycerol and other non-toxic polyols.

Optionally, a coating of color (caramel, spices or artificial colors) and flavor (smokes, spices, artificial flavors) can be applied to the PVA after it has been cast as a film, either by spraying the material directly onto the film or by rolling a solution of material on the film. It is also within the scope of the invention to prepare a second color/flavor film and to laminate this to the PVA film itself. Films are produced either by a solution casting process, or by conventional film-forming processes such as blown film extrusion or standard film extrusion.

The fully hydrolyzed PVA films are soluble only in hot water at temperatures above 90° C. These films are used under normal procedures in the processing of meat products and are then removed intact following processing. PVA-based films of this kind exhibit a number of advantages relative to films currently used to contain the meat product during processing and then removed. In particular:
PVA based films exhibit much greater strength and tear resistance than do conventional cellulose films.
PVA based films can be perforated without minimal reduction to their tear resistance, unlike cellulose films.
PVA based films exhibit enhanced permeability to smoke when compared with conventional cellulose films and polyolefin films
most importantly for a large scale commercial meat processing operation, the PVA film does not bind to the meat product following processing and actually lifts away naturally from the meat products once cooled. However, the film can be formulated to bind to the netting wrap during processing.
PVA based films can be coated with coloring and flavor agents which are transferred to the meat product during cooking. On removal of the film following processing the color and/or flavor remains with the surface of the meat product.

As noted above, when the PVA used in making films according to present invention only partially hydrolyzed, it will dissolve at various processing temperatures below 90° C., suitable for use in meat processing in those situations in which the processor would wish to have the film dissolve off the meat product, particularly in the processing of a ham.

It is preferable that the films be made with a thickness of in the range of 20-40 microns to ensure ease of handling relative to thicker films. Too, the thinner films produce a more attractive netting imprint on the finished meat product and allow for the maximum penetration of smoke used to color the meat product.

Using the processing of a ham with a fully hydrolyzed PVA film, the ham is first stuffed into the film in the conventional way, then covered with nettings to form the standard ham shape. The ham is then processed under a normal smoking cycle, which involves drying, smoking and cooking the ham to the requisite internal temperature. The finished cooked hams are showered and allowed to cool and the netting and film removed together to complete the final product prior to packing.

We have found that showering the meat product after cooking helps to hydrate the film, aiding in the removal of the film from the meat source.

In the situation where PVA film is removed during the cooking process, the film is melted off the ham in the cooking cycle as the temperature of the film reaches greater than about 50° C. The exact temperature can be controlled to some extent by selecting the degree of hydrolysis of the PVA polymer used.

1. (canceled)

2. A meat packaging film according to claim 5, wherein said plasticizing polyol comprises glycerol.

3. A meat packaging film according to claim 2, further comprising up to 20 wt. % of a polymeric modifying agent for stabilizing the film against dissolution in hot water, said modifying agent being selected from the group consisting of gums, proteins and starches.

4. A meat packaging film according to claim 3, wherein said modifying agent comprises gellan gum or konjac gum.

5. A water soluble meat packaging film prepared by solution casting or extrusion of a liquid composition comprising a uniform mixture of from 65-80 wt. % of polyvinyl alcohol, from 2-20 wt. % of water and up to 20 wt. % of a non-toxic plasticizing polyol.

6. A meat packaging film according to claim 5, further comprising a color and/or flavor coating applied to the film after casting.

7. A meat processing film according to claim 5, having a thickness in the range of 20 to 40 microns.

8. A meat processing film according to claim 5, wherein said polyvinyl alcohol is partially hydrolyzed.
